(19) United States
(12) Patent Application Publication
(10) Pub. No.: US 2022/0380111 A1
(43) Pub. Date: Dec. 1, 2022

(54) ROTISSERIE STRAINER DEVICE

(71) Applicant: Mac F. Clark, Henderson, NV (US)

(72) Inventor: Mac F. Clark, Henderson, NV (US)

(21) Appl. No.: 17/331,648

(22) Filed: May 27, 2021

(51) Int. Cl. B65D 81/26

(52) U.S. Cl. CPC B65D 81/262; B65D 2581/3456

(57) ABSTRACT

A rotisserie strainer device; the rotisserie strainer device includes a platform sized and configured to be positionable in a bottom-portion of a host rotisserie-goods-container and elevate a rotisserie-food-item from an interior base section of the rotisserie-goods-container. The platform includes a planar section having a plurality of apertures allowing liquid to pass therethrough, a center support, a first-foot, and a second-foot. The platform is provided for elevating the rotisserie-food-item from the interior base section of the host rotisserie-goods-container in order to prevent contact between the rotisserie-food-item and the liquid collected in the bottom-portion of the host rotisserie-goods-container.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of strainers of existing art and more specifically relates to food strainer devices.

### RELATED ART

Prepared rotisserie goods such as chickens that are sold in grocery stores nationwide are typically packaged in plastic containers. With these traditional plastic containers, the chickens sit in their own grease and liquids, and often do so for long periods of time until someone purchases it. As the food sits in the container, the accumulation of pooled liquid, whether grease, oil, sauces, or water moisture, causes the food to lose freshness and become less edible. In some cases, the food can become spoiled and unappetizing in a short period of time. A suitable solution is desired.

U.S. Pat. No. 10,327,390 to Barbara Hanshew relates to a food storage system. The described food storage system includes a food storage system for enhancing freshness of a perishable food item which includes a bowl that is positioned on a support surface. A plate is provided and the plate is selectively positioned in the bowl. The plate is perforated to pass air between the plate and the bowl. A food item is selectively positioned on the plate thereby facilitating the food item to be kept dry. In this way the plate inhibits the food item from rotting and the plate enhances freshness of the food item.

### SUMMARY OF THE INVENTION

In view of the foregoing disadvantages inherent in the known food strainer device art, the present disclosure provides a novel rotisserie strainer device. The general purpose of the present disclosure, which will be described subsequently in greater detail, is to provide a rotisserie strainer device for containers that host cooked rotisserie goods, such as chicken and turkey, which enhance flavor, texture and enjoyability of said rotisserie goods.

A rotisserie strainer device is disclosed herein. The rotisserie strainer device includes a platform sized and configured to be positionable (or positioned) in a bottom-portion of a host rotisserie-goods-container and thereby elevate a rotisserie-food-item from an interior base section of the rotisserie-goods-container. The platform comprises a planar section having a plurality of apertures allowing liquid to pass therethrough, a center support, a first-foot, and a second-foot. The platform is provided for elevating the rotisserie-food-item from the interior base section of the host rotisserie-goods-container in order to prevent contact between the rotisserie-food-item and the liquid collected in the bottom-portion of the host rotisserie-goods-container.

A method of using the rotisserie strainer device is also disclosed herein. The method includes the following steps: step one, providing a platform sized and configured to be positionable in a bottom-portion of a host rotisserie-goods-container and able to elevate a rotisserie-food-item from an interior base section of the rotisserie-goods-container; step two, inserting the platform in the host rotisserie-goods-container; step three, placing a rotisserie-food-item on the platform; and step four, optionally removing the platform from the host rotisserie-goods-container.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a rotisserie strainer device, constructed and operative according to the teachings of the present disclosure.

FIG. 1 is a perspective view of the rotisserie strainer device during an ‘in-use’ condition, according to an embodiment of the disclosure.

FIG. 2 is a top perspective view of the rotisserie strainer device of FIG. 1, according to an embodiment of the present disclosure.

FIG. 3 is a top view of the rotisserie strainer device of FIG. 1, according to an embodiment of the present disclosure.

FIG. 4 is a perspective view of the rotisserie strainer device in an inserted, ‘ready for use’ condition of FIG. 1, according to an embodiment of the present disclosure.

FIG. 5 is a perspective view of the rotisserie strainer device of FIG. 1, according to an embodiment of the present disclosure.

FIG. 6 is a perspective view of the rotisserie strainer device of FIG. 1, according to an embodiment of the present disclosure.

FIG. 7 is a perspective view of a kit of the rotisserie strainer device of FIG. 1, according to an embodiment of the present disclosure.

FIG. 8 is a flow diagram illustrating a method of using a rotisserie strainer device, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a food strainer device and more particularly to a rotisserie strainer device as used to improve the storage of rotisserie-food-items.

Generally, the rotisserie strainer device includes a platform that may be inserted in a host rotisserie-goods-container for supporting a rotisserie-food-item, such as a chicken in an elevated position within the rotisserie-goods-container. The platform features a plurality of apertures allowing liquid to pass therethrough. Grease, fat liquid and/or particulate fall through the plurality of apertures to a bottom of the rotisserie-goods-container instead of remaining in contact with the rotisserie-food-item. The platform further includes strategically-placed creases that form support walls to ensure the platform is rigid and durable under pressure of hosting a cooked rotisserie-food-item such as a chicken or turkey. The rotisserie strainer device allows a popular prepared food item to be packaged and served in a cleaner, taste-preserving, and healthier way.

In one embodiment, using high-density polyethylene (HDPE) of a one-millimeter (1 mm) depth, the rotisserie strainer device is formed in a similar size and shape to a rotisserie-goods-container used for hosting single units of prepared rotisserie chickens and the like. A platform portion of the rotisserie strainer device includes circular apertures of an approximate two-millimeter (2 mm) diameter. A horizontal center of the rotisserie strainer device features a stabilizing crease and the outer edge projects perpendicularly to form a secure footing.

The rotisserie strainer device can be made in various sizes and shapes that correspond with a rotisserie-goods-container. A various number of apertures of various sizes can be featured on the platform of the rotisserie strainer device. The rotisserie strainer device can be made in variations in which the platform is a permanently-affixed feature of its hosting container. The rotisserie strainer device can be made of various materials of adequate durability and weight tolerance, such as but not limited high-density polyethylene (HDPE), high-impact polystyrene (HIPS), polyvinyl chloride (PVC), and polyethylene terephthalate (PET). The rotisserie strainer device can be made in variations that use corrugated plastic.

A method of use may be as follows: the rotisserie strainer device may be applied directly into a rotisserie-goods-container before insertion of a rotisserie-food-item. A cooked, rotisserie-food-item may then be placed upon the rotisserie strainer device and any grease and fat may drain from the rotisserie-food-item through apertures of the platform. The grease and fat will remain on an interior base section of the rotisserie-goods-container and will not make any further contact with, or be reabsorbed by, the hosted rotisserie-food-item. Users may then enjoy all parts of the rotisserie-food-item such as a chicken without it being saturated with unwanted grease and fat.

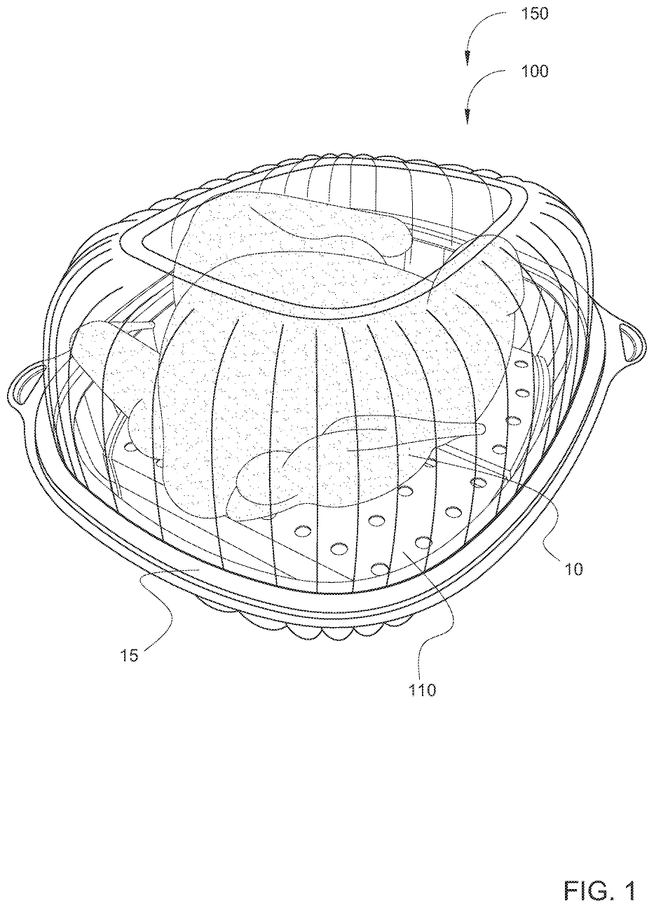

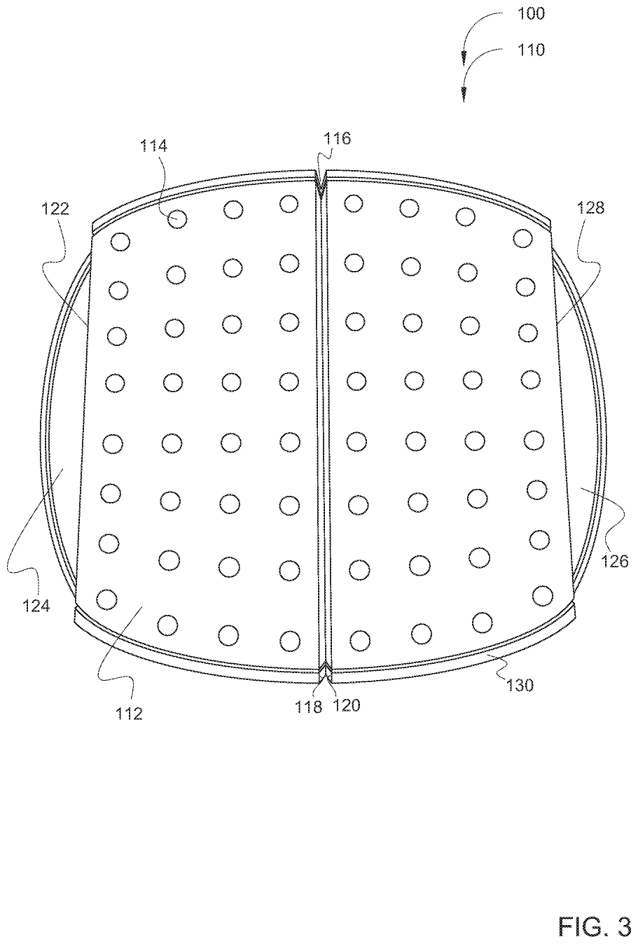

Referring now more specifically to the drawings by numerals of reference, there is shown in FIGS. 1-6, various views of a rotisserie strainer device 100.

FIG. 1 shows a rotisserie strainer device 100 during an ‘in-use’ condition 150, according to an embodiment of the present disclosure. Here, the rotisserie strainer device 100 may be beneficial for use by a user to preserving a freshness of a rotisserie-food-item 10. As illustrated, the rotisserie strainer device 100 may include a platform 110 sized and configured to be positionable in a bottom-portion of a host rotisserie-goods-container 15 and elevate a rotisserie-food-item from an interior base section of the rotisserie-goods-container 15.

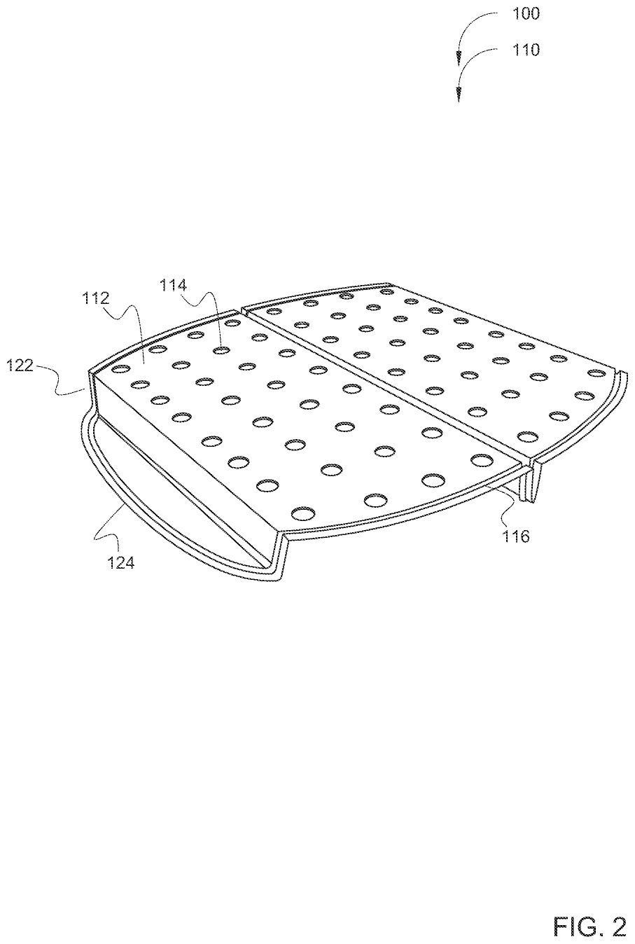

FIG. 2 shows the rotisserie strainer device 100 of FIG. 1, according to an embodiment of the present disclosure. As above, the rotisserie strainer device 100 may include the platform 110. The platform 110 includes a planar section 112 having a plurality of apertures 114 allowing liquid to pass therethrough, a center support 116, a first-foot 124, and a second-foot 126. The platform 110 is provided for elevating the rotisserie-food-item from the interior base section of the host rotisserie-goods-container 15 in order to prevent contact between the rotisserie-food-item and the liquid collected in the bottom-portion of the host rotisserie-goods-container 15. As shown in the illustrations, the plurality of apertures 114 may be circular in shape and may be equidistantly spaced along the planar section 112. In a preferred embodiment, the plurality of apertures 114 each comprise a diameter of approximately 2 millimeters and allow passage of liquids including fat, grease and water therethrough.

As shown in the figures, the platform 110 includes the planar section 112 having a crease at a horizontal center forming a first-support-wall 118 and a second-support-wall 120 together forming the center support 116. The planar section 112 further comprises a first-creased-edge 122 and a second-creased-edge 128 opposing the first-creased-edge 122. The first-foot 124 extends perpendicularly from the first-creased-edge 122 and the second-foot 126 extends perpendicularly from the second-creased-edge 128. The first-foot 124 and the second-foot 126 each comprise an L-shaped profile. The platform 110 forms a cavity between a top surface 108 of the platform 110 and the interior base section of the rotisserie-goods-container 15 for collection of the liquid. The rotisserie strainer device 100 may be made to rest at various heights above the interior base section of the rotisserie-goods-container 15.

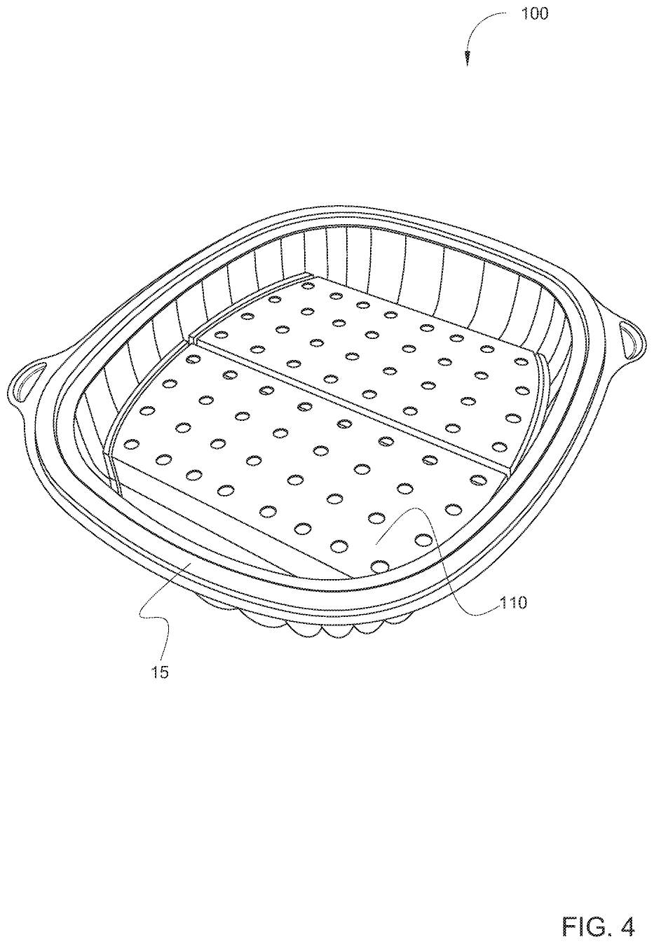

FIG. 4 is a perspective view of the rotisserie strainer device 100 in an inserted, ‘ready for use’ condition of FIG. 1, according to an embodiment of the present disclosure. The rotisserie strainer device 100 includes the platform 110 comprising the center support 116, the first-foot 124, and the second-foot 126. The center support 116, the first-foot 124, and the second-foot 126 are configured to support a mass of the rotisserie-food-item when placed on the top surface 108 of the planar section 112 of the platform 110. The rotisserie-food-item may include a chicken, a turkey, prime rib, short-back ribs, and other rotisserie-food-items. The rotisserie strainer device 100 allows fat and grease to drain from rotisserie-food-items and through the plurality of apertures 114. The rotisserie strainer device 100 maintains a rotisserie-food-item in a position above pooled fat and grease.

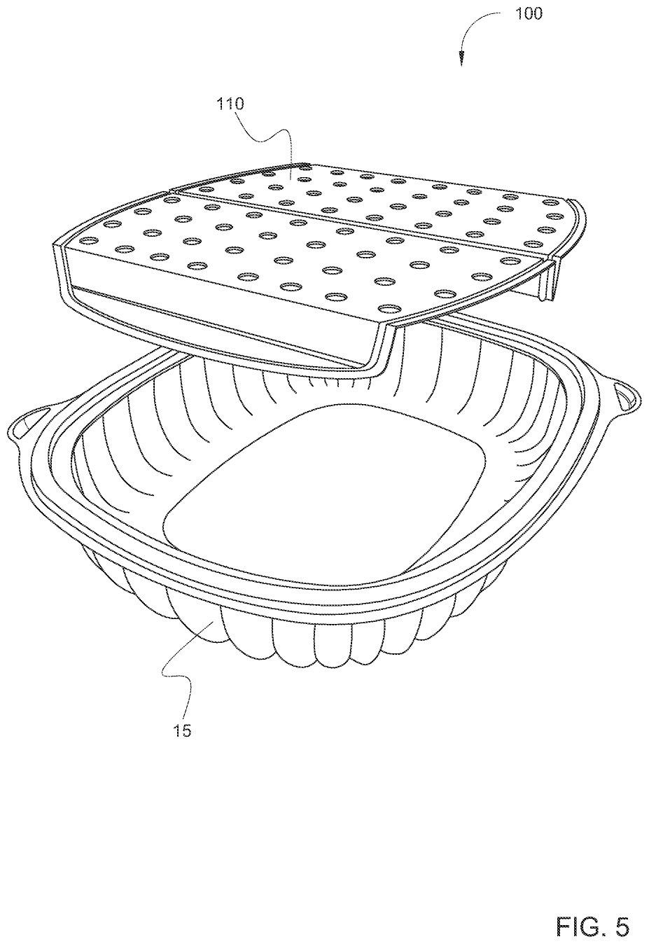

FIG. 5 is a perspective view of the rotisserie strainer device 100 of FIG. 1, according to an embodiment of the present disclosure. In certain embodiments, the platform 110 is removable from the host rotisserie-goods-container 15. In alternative embodiments, the platform 110 is non-removable from the host rotisserie-goods-container 15.

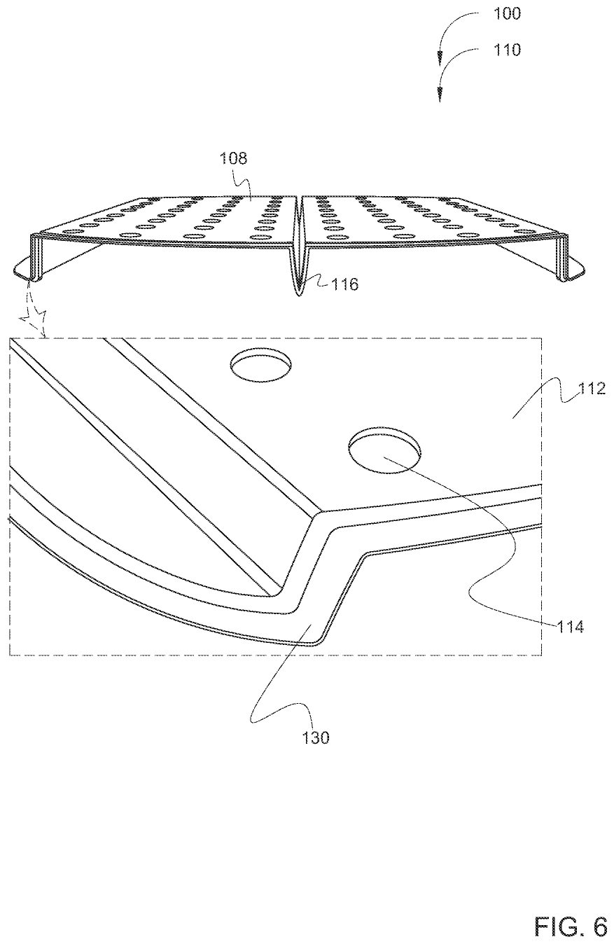

FIG. 6 is a perspective view of the rotisserie strainer device 100 of FIG. 1, according to an embodiment of the present disclosure. In a preferred embodiment, the platform 110 comprises a creased outer edge 130 along an outer perimeter of the platform 110. The creased outer edge 130 along the outer perimeter of the platform 110 provides additional strength and durability. The outer perimeter of the platform 110 comprises a curved profile contouring interior sidewalls of the host rotisserie-goods-container 15.

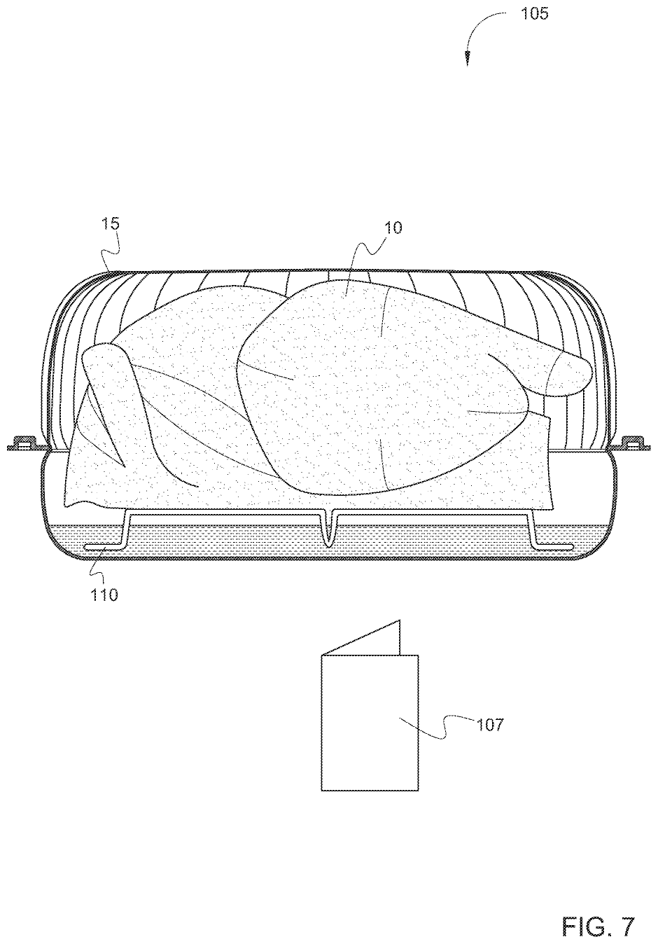

According to one embodiment, the rotisserie strainer device 100 may be arranged as a kit 105, as shown in FIG. 7. In particular, the rotisserie strainer device 100 may further include a set of instructions 107, a host rotisserie-goods-container 15, and a lid. The instructions 107 may detail functional relationships in relation to the structure of the rotisserie strainer device 100 such that the rotisserie strainer device 100 can be used, maintained, or the like, in a preferred manner.

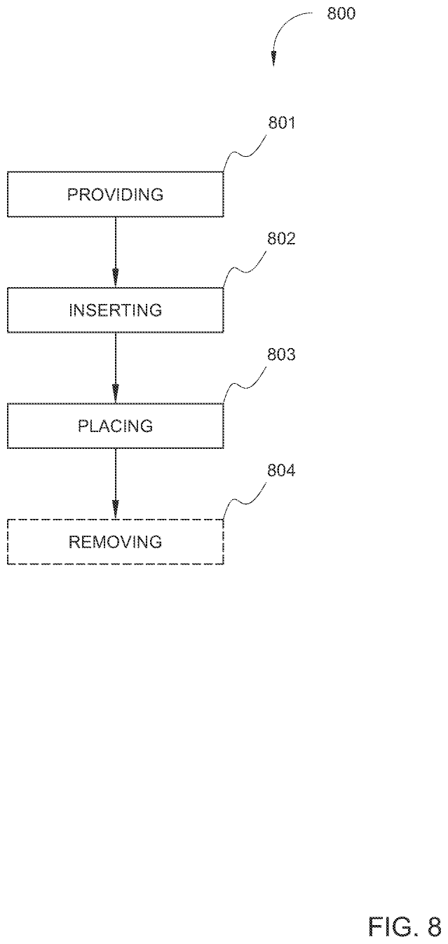

FIG. 8 is a flow diagram illustrating a method of using a rotisserie strainer device 100, according to an embodiment of the present disclosure. In particular, the method for using a rotisserie strainer device 800 may include one or more components or features of the rotisserie strainer device 100 as described above. As illustrated, the method for using the rotisserie strainer device 800 may include the steps of: step one 801, providing a platform 110 sized and configured to be positionable in a bottom-portion of a host rotisserie-goods-container 15 and able to elevate a rotisserie-food-item from an interior base section of the rotisserie-goods-container 15; step two 802, inserting the platform 110 in the host rotisserie-goods-container 15; and step three 803, placing a rotisserie-food-item on the platform 110; and step four 804 removing the platform 110 from the host rotisserie-goods-container 15.

It should be noted that step four 804 is an optional step and may not be implemented in all cases. Optional steps of method of use 800 are illustrated using dotted lines in FIG. 8 so as to distinguish them from the other steps of method of use 800. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for using the rotisserie strainer device, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A rotisserie strainer device, said rotisserie strainer device comprising:
a platform sized and configured to be positionable in a bottom-portion of a host rotisserie-goods-container and able to elevate a rotisserie-food-item from an interior base section of said rotisserie-goods-container, said platform including,
a planar section having,
a plurality of apertures allowing liquid to pass therethrough,
a center support,
a first-foot, and
a second-foot, and
wherein said platform is provided for elevating said rotisserie-food-item from said interior base section of said host rotisserie-goods-container in order to prevent contact between said rotisserie-food-item and said liquid collected in said bottom-portion of said host rotisserie-goods-container.

2. The rotisserie strainer device of claim 1, wherein said plurality of apertures are circular in shape.

3. The rotisserie strainer device of claim 2, wherein said plurality of apertures are equidistantly spaced along said planar section.

4. The rotisserie strainer device of claim 3, wherein each of said plurality of apertures comprise a diameter of approximately 2 millimeters.

5. The rotisserie strainer device of claim 1, wherein said planar section comprises a crease at a horizontal center forming a first-support-wall and a second-support-wall together forming said center support.

6. The rotisserie strainer device of claim 1, wherein said planar section further comprises a first-creased-edge and a second-creased-edge opposing said first-creased-edge.

7. The rotisserie strainer device of claim 6, wherein said first-foot extends perpendicularly from said first-creased-edge and said second-foot extends perpendicularly from said second-creased-edge.

8. The rotisserie strainer device of claim 7, wherein said first-foot and said second-foot comprise an L-shaped profile.

9. The rotisserie strainer device of claim 1, wherein said platform forms a cavity between a top surface of said platform and said interior base section of said rotisserie-goods-container for collection of said liquid.

10. The rotisserie strainer device of claim 9, wherein said liquid includes grease and fat.

11. The rotisserie strainer device of claim 9, wherein said center support, said first-foot, and said second-foot are configured to support a mass of said rotisserie-food-item when placed on said top surface of said planar section.

12. The rotisserie strainer device of claim 12, wherein said rotisserie-food-item is selected from the group consisting of a chicken, a turkey, prime rib, and short-back ribs.

13. The rotisserie strainer device of claim 1, wherein said platform is removable from said host rotisserie-goods-container.

14. The rotisserie strainer device of claim 1, wherein said platform is non-removable from said host rotisserie-goods-container.

15. The rotisserie strainer device of claim 1, wherein said platform comprises a creased outer edge along an outer perimeter of said platform.

16. The rotisserie strainer device of claim 15, wherein said outer perimeter of said platform comprises a curved profile contouring interior sidewalls of said host rotisserie-goods-container.

17. A rotisserie strainer device, said rotisserie strainer device comprising:
a platform sized and configured to be positionable in a bottom-portion of a host rotisserie-goods-container and able to elevate a rotisserie-food-item from an interior base section of said rotisserie-goods-container, said platform including,
a planar section having,
a plurality of apertures allowing liquid to pass therethrough,
a center support,
a first-foot, and
a second-foot, and
wherein said platform is provided for elevating said rotisserie-food-item from said interior base section of said host rotisserie-goods-container in order to prevent contact between said rotisserie-food-item and said liquid collected in said bottom-portion of said host rotisserie-goods-container;
wherein said plurality of apertures are circular in shape;
wherein said plurality of apertures are equidistantly spaced along said planar section;
wherein each of said plurality of apertures comprise a diameter of approximately 2 millimeters;
wherein said planar section comprises a crease at a horizontal center forming a first-support-wall and a second-support-wall together forming said center support;
wherein said planar section further comprises a first-creased-edge and a second-creased-edge opposing said first-creased-edge;
wherein said first-foot extends perpendicularly from said first-creased-edge and said second-foot extends perpendicularly from said second-creased-edge;
wherein said first-foot and said second-foot comprise an L-shaped profile;
wherein said platform forms a cavity between a top surface of said platform and said interior base section of said rotisserie-goods-container for collection of said liquid;
wherein said liquid includes grease and fat;
wherein said center support, said first-foot, and said second-foot are configured to support a mass of said rotisserie-food-item when placed on said top surface of said planar section;
wherein said platform is removable from said host rotisserie-goods-container;
wherein said platform comprises a creased outer edge along an outer perimeter of said platform; and
wherein said outer perimeter of said platform comprises a curved profile contouring interior sidewalls of said host rotisserie-goods-container.

18. The rotisserie strainer device of claim 17, further comprising:
a set of instructions,
a host rotisserie-goods-container,
a lid, and
wherein the rotisserie strainer device is arranged as a kit.

19. A method of using a rotisserie strainer device, said method comprising the steps of:
providing a platform sized and configured to be positionable in a bottom-portion of a host rotisserie-goods-container and able to elevate a rotisserie-food-item from an interior base section of said rotisserie-goods-container;
inserting said platform in said host rotisserie-goods-container; and
placing a rotisserie-food-item on the platform.

20. The method of claim 19, further comprising the steps of:
removing said platform from said host rotisserie-goods-container.
